(19) United States
(12) Patent Application Publication
(10) Pub. No.: US 2003/0061722 A1
(43) Pub. Date: Apr. 3, 2003

(54) Polygrid

(76) Inventor: Wade R. Bradley, Hot Springs, AR (US)

Correspondence Address: Ray F. Cox, Jr., Wright, Lindsey & Jenning LLP, Suite 2200, 200 West Capitol Avenue, Little Rock, AR, 72201, US

(21) Appl. No.: 09/967,551

(22) Filed: Sep. 28, 2001

(51) Int. Cl. G01B 3/14

(52) U.S. Cl. 33/563; 33/1 B; 33/1 G

(57) ABSTRACT

A simple, general-purpose measuring and locating device to assist in laying out construction projects is a full-scale sheet of dimensionally stable material, preferably polyethylene of suitable thickness, on which markings, preferably in a grid pattern, are impressed, printed, embossed, fused or similarly expressed on the sheet. The grid pattern is dimensioned to be most useful in laying out various types of projects without the necessity of measuring the location of each aspect of the project separately. In preferred embodiments, the grid is in one inch or one foot squares with a different color or line type to indicate sixteen inch centers to assist in determining the location of walls, studs, plumbing fixtures and the like.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND OF THE INVENTION

1. Field of the Invention

The present invention relates to a device for assisting in laying out construction projects, and in particular, to such a device which comprises a sheet of dimensionally stable material with a general purpose reference grid imprinted thereon.

2. Brief Description of the Related Art

Laying out construction projects can be a tedious and time consuming task. For example, the construction of the foundation of even a simple structure typically requires placing corner posts and batter boards to establish references points that are properly spaced and oriented and which define lines that are square to one another. Other types of construction work that require similar tedious measurement tasks include laying out the position of walls, floor tiles, outdoor decks, brick patios or walkways, landscaping, and the like.

Information relevant to attempts to address these problems can be found in U.S. various U.S. patent as described below. However, each of these references suffers from one or more disadvantages. The following patents disclose templates and the like which are limited to specific purposes.

U.S. Pat. No. 4,573,295 discloses a full size pattern marked with indicia to define locations of the elements of a pre-designed structure. U.S. Pat. No. 4,573,302 discloses the use of full scale, dimensionally stable, flexible templates to mark foundation footings and plumbing trenches required for houses. Another such full scale template is used to mark the location of various construction items. The sheet used to indicate the location of the foundation trench is provided with a set of dotted or dashed lines for indicating the various features which are marked by stakes driven through openings in the sheet. The markings include not only the foundation trenches but location of various plumbing features. Likewise, the sheet used to begin the building construction is marked by indicia to indicate the location of walls, window and door openings, electrical outlets and the like. A closely related concept is disclosed in U.S. Pat. No. 3,816,931 for an architectural template comprising a dimensionally stable, full size fabric sheet with architectural reference lines placed thereon.

More general measurement systems imprinted on sheets are disclosed in U.S. Pat. Nos. 5,673,489 and 5,195,249.

U.S. Pat. No. 5,673,489 discloses a gridded measurement system imprinted on the surfaces of construction materials. It is noted that the measurement system may use inch or metric units, whole or fractional units, lines marking commonly used measurements such as 16 inch centers, various colored lines, and dotted, dashed or otherwise enhanced lines. The disclosure indicates that the measurement system may be used on any type of construction material, although the construction materials described are those types of materials that must be cut to exact measurements on a job site. Therefore this patent does not disclose imprinting such a measurement system on a dimensionally stable sheet that would be used to mark locations at a job site.

U.S. Pat. No. 5,195,249 discloses a template made of a thin transparent sheet of material. Although in the primary embodiment the material is specifically paper, the claims are not so limited. The template has markings such as level lines and measurement scales to assist in marking the location of windows, doors, etc. This patent does not disclose a measurement grid per se.

References mentioned in this background section are not admitted to be prior art with respect to the present invention. The limitations of the prior art are overcome by the present invention as described below.

### BRIEF SUMMARY OF THE INVENTION

The present invention is directed to a device that satisfies the need for a simple general-purpose measuring and locating device to assist in laying out construction projects. It comprises a full-scale sheet of dimensionally stable material, preferably polyethylene of suitable thickness, on which markings, preferably in a grid pattern, are impressed, printed, embossed, fused or similarly expressed on the sheet. The grid pattern would desirably be dimensioned to be most useful in laying out various types of construction projects without the necessity of measuring the location of each aspect of the project separately. For example, if used for framing a house, the grid could be in one inch squares with a different color or line type to indicate sixteen inch centers to assist in determining the location of walls, studs, plumbing fixtures and the like.

As another example, the invention could be used to lay out foundations by placing the sheet on leveled ground, determining the location of the foundation by comparing a drawing to the dimensioned grid and marking the appropriate locations directly through the sheet without the necessity of setting batter boards and pulling string lines. The sheet could be reused or left in place to be used as a vapor barrier under poured concrete. The sheet has a dual purpose in that it could be used for all purposes to which plastic sheeting is now put in construction projects, e.g., vapor barrier, drop sheet, etc., as well as all dimensioning and lay out functions.

Since the sheet would be essentially a large sheet of graph paper, it could be used for various other purposes, including positioning columns for decks, laying out patios and sidewalks, laying out plumbing connections, landscaping and the like. The invention can be cheaply made and has general utility for all types of projects where measurements are required. A gridded plastic sheet has the advantage of providing accurate and square measurements more simply and quickly than conventional construction methods.

It is a significant aspect of this invention that it may be used for general purposes requiring dimensioning and lay out functions and is not specific to a single type of construction project or to one specific example of a building or construction project.

### BRIEF DESCRIPTION OF THE SEVERAL VIEWS OF THE DRAWINGS

These and other features, objects and advantages of the present invention will become better understood from a consideration of the following detailed description, appended claims and accompanying drawings where:

FIG. 1 is a perspective view of a ground area selected for a construction project wherein a plurality of the flexible gridded sheets of the present invention are place to encompass the construction area. The planned location of foundation walls or footings are indicated by dashed lines which are located with respect to the measurement indicia of the flexible gridded sheets.

FIG. 2 is a perspective view of the construction area of FIG. 1 showing the finished foundation walls and footings as layed out according to the dashed lines of FIG. 1. The flexible gridded sheets are shown placed into the excavation within the foundation walls and footings so as to act as a vapor barrier under a floor slab which may be poured directly over the flexible gridded sheets.

FIG. 3 is a plan view of the flexible gridded sheet of the present invention.

FIG. 4 is a plan view of a landscaping project layed out using a plurality of the flexible gridded sheets of the present invention wherein plants may be placed according to planned locations using the measurement indicia of the flexible gridded sheets which are left in place for moisture and weed control purposes.

FIG. 5 is a perspective view of a construction area for a slab foundation wherein the flexible sheet of the present invention is used both to locate the foundation form and as a vapor barrier under the poured concrete slab foundation.

### DETAILED DESCRIPTION OF THE INVENTION

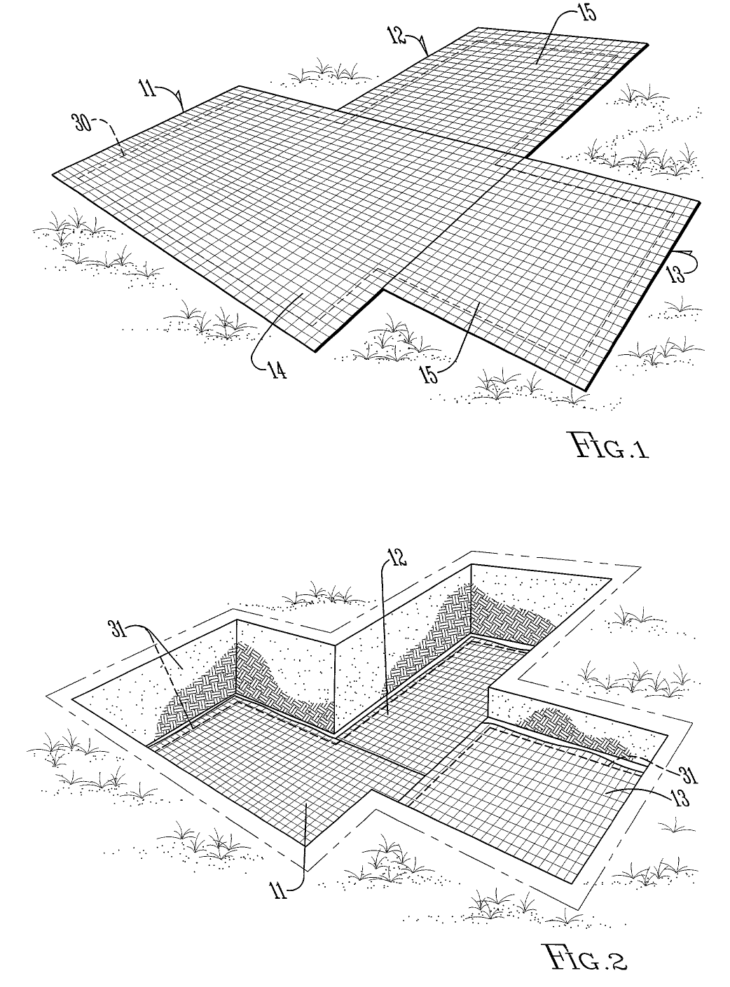

With reference to FIGS. 1-4, the preferred embodiment of the present invention may be described. The present invention is a simple general-purpose measuring and locating device to assist in laying out construction projects. The term “construction project” as used herein in intended to include, without limitation, the construction, placement or design of foundation footings, slab foundations, full basement foundation walls, patios, sidewalks, elevated decks, post buildings and pole barns, fencing, landscaping, gardening, pools and ponds, plumbing and electrical rough-in, sub-floor nail or screw spacing, stud wall lay out, wall, ceiling or floor tile, vinyl flooring, playground structures, and manufacturing equipment.

The present invention comprises a full-scale flexible sheet 10 of dimensionally stable material, preferably polyethylene of suitable thickness, on which measurement indicia, preferably in a grid pattern, are impressed, printed, embossed, fused or similarly expressed on the flexible sheet 10. The choice of material depends on the application, but must be sufficiently dimensionally stable so that the material cannot be substantially stretched so as to distort the measurement indicia described below. Depending upon the projected uses, the flexible sheet 10 would desirably be provided in the thicknesses that are currently standard for flexible plastic sheeting, such as 4 mill, 6 mill, etc. The grid pattern is desirably dimensioned to be most useful in laying out various types of construction projects without the necessity of measuring the location of each aspect of the project separately. The flexible sheet 10 may be of various dimensions so that each flexible sheet is of sufficient size to cover a substantial portion of the area of the construction project. If a single flexible sheet 10 is not of sufficient size or if the construction project is irregularly shaped, then a plurality of the flexible sheets 10 may be employed to cover the entire area. The flexible sheet 10 may be manufactured in the standard sizes that are commonly available for plastic sheeting that is used currently in place of drop cloths for painters or as vapor barriers. Such standard sizes include 10 feet by 20 feet, 10 feet by 50 feet, 15 feet by 50 feet, 20 feet by 50 feet, etc. Providing the flexible sheet 10 of the present in such standard sizes would allow flexibility in the use of the flexible sheets 10 in a wide range of construction projects. As an example, FIG. 1 shows a construction project in which a house foundation is to be constructed. An L-shaped house plan is divided into a main section 11 and a wing section 12. A garage section 13 projects from the house main section. A large sheet 14 may be used over the main section 11, while smaller sheets 15 may be used over the wing section 12 and the garage section 13.

As shown in a preferred embodiment in FIG. 3, the flexible sheet 10 is provided with full-scale measurement indicia comprising a regular rectangular grid. The rectangular grid comprises a first plurality of lines 20 at a first uniform spacing across a first dimension of the flexible sheet 10 and a second plurality of lines 21 at a second uniform spacing across a second dimension of the flexible sheet 10. The first plurality of lines 20 and the second plurality of lines 21 are preferable at mutual right angles so that the first and second plurality of lines 20, 21 form a regular rectangular grid. The spacing between successive lines may be of various magnitudes depending upon the application. When highly precise measurements are required, the grid spacing may be an one inch intervals. In other applications, a six inch spacing might give sufficient accuracy will not unduly cluttering the surface of the flexible sheet 10. For most applications, a one foot spacing may be adequate. In the latter case, the one foot grid may be supplement by placing indicator marks 22 at one inch intervals along the first and second plurality of lines 20, 21.

Particular applications may be benefited by having additional commonly-employed measurement intervals indicated on the flexible sheet 10. In applications where the flexible sheet 10 is used in carpentry, such an arrangement of one foot grid spacing and one inch interval marks may be supplemented with visually enhanced grid lines 23 at 16 inch intervals. The visually enhanced grid lines 23 are desirably enhanced by using a different color from the color or the one foot grid lines or may be enhanced by having a different thickness or by having some other distinguishing characteristic, such as being dotted or dashed. The visually enhanced grid lines 23 would comprise a third plurality of lines 24 and a fourth plurality of lines 25 to form a rectangular grid at a uniform 16 inch spacing. It may be seen that superimposing a sixteen inch grid on a one foot grid would require certain of the lines of the two grid systems to be located at the same place. In such case, either grid system could be dominant. For example, if the sixteen inch grid were to be dominant with the visual enhancement based on color, the grid lines where the sixteen inch grid coincided with the one foot grid lines would receive the color of the visually enhanced sixteen inch lines.

In some applications, it might be desirable to be able to lay out lines at 45 degree angles. In on embodiment of the present invention, the first and second plurality of lines 20, 21 define a plurality of squares, which are provided with a center indicator mark 26. The center indicator mark 26 may be cross hairs, dots, open circles, or various other forms of center indicators.

The flexible sheet 10 of the present invention therefore provides a general purpose measurement system and is not limited to a single type of construction project or to one specific example of a building or construction project as would, for example, a template. The present invention is also unique in that the flexible sheet 10 may be employed for purposes other than measurement and lay out of construction projects. Flexible plastic sheets are commonly employed for use in place of drop cloths for painters, as vapor barriers under poured concrete, as vapor barriers in walls, and as cover materials in landscaping for control of moisture and weeds. The present invention thus may function in multiple applications having more than one purpose.

For example, if used for framing a house, the flexible sheet 10 may assist in determining the location of walls, studs, plumbing fixtures and the like, after which it may be employed as a vapor barrier in the walls of the house.

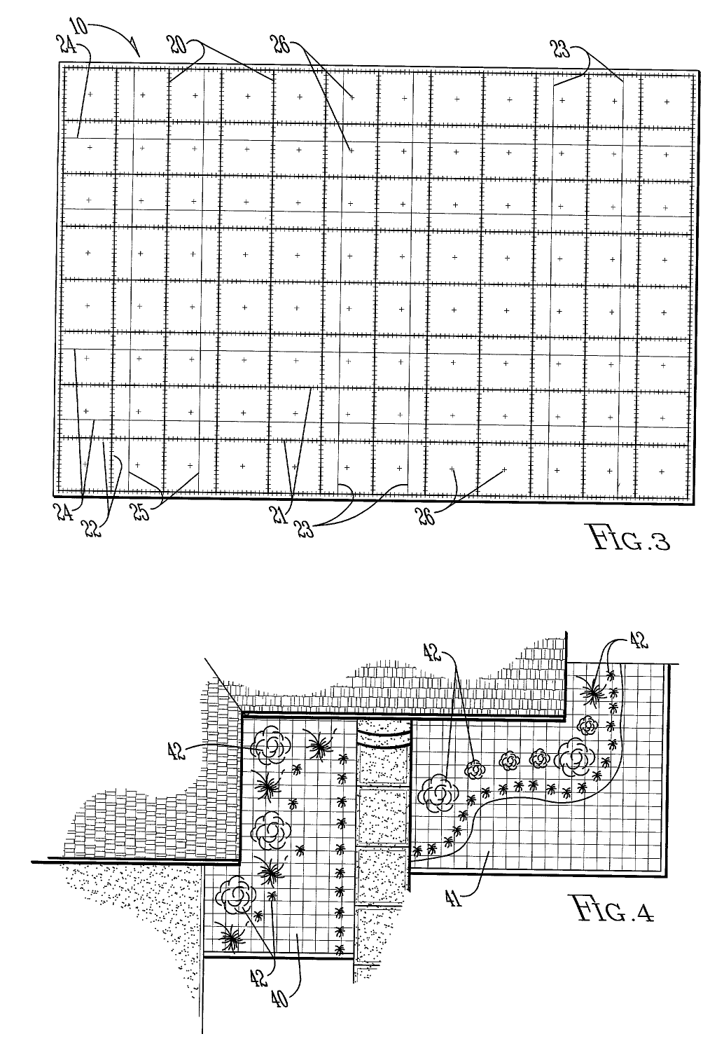

With reference to FIGS. 1-2, as another example, the present invention may be used to lay out foundations by placing one or more flexible sheets 11, 12, 13 on leveled ground, determining the location of the foundation by comparing a drawing to the dimensioned grid of the flexible sheets 11, 12, 13 and marking the appropriate locations directly through the flexible sheets 11, 12, 12 as shown by the dashed line 30 without the necessity of setting batter boards and pulling string lines. After excavation, the concrete foundation walls or footings 31 are poured. The flexible sheets 11, 12, 13 may be reused or, after being moved as necessary to excavate the foundation, placed in the excavation to be used as a vapor barrier under a poured concrete floor slab.

As shown in FIG. 5, the present invention may be used to lay out a slab foundation by placing the flexible sheet 10 on leveled ground and pinning the flexible sheet 10 in position by, for example, driving nails 16 through the flexible sheet 10 into the ground. The location of the foundation is then determined with reference to the dimensioned grid defined by lines 20, 21 and the appropriate locations are marked by placing stakes 50 directly through the flexible sheet 10 into the leveled ground surface. Form boards 51 are then attached to the stakes 50 and fastened together to create a form bounding the perimeter of the desired slab foundation. The flexible sheet 10 is left in place to be used as a vapor barrier under the slab foundation, which is formed by pouring concrete into the form and over the flexible sheet 10.

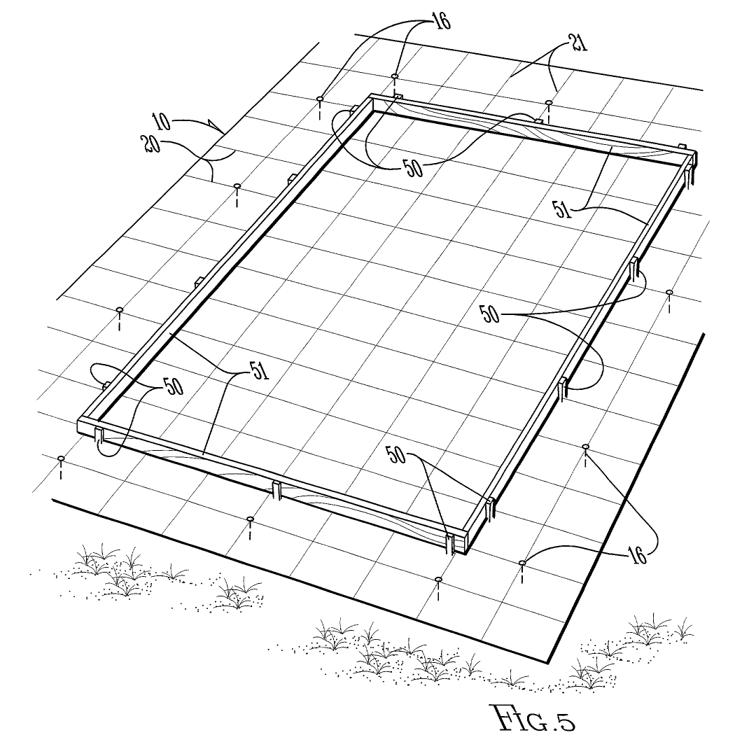

Another method of achieving a dual use of the present invention is described with reference to FIG. 4, which illustrates a landscaping project. Flexible sheets 40, 41 are placed in the area to be landscaped. The location of plantings 42 are determined to a landscaping plan and the locations are marked by reference to the measurement grid on the flexible sheets 40, 41. The flexible sheets 40, 41 may be cut and pulled back from the location of each of the plantings 42, a hole dug for each of the plantings 42, and the plantings 42 placed in the hole. The flexible sheets 40, 41 may then be left in place for moisture and weed control. For the sake of appearance and to delay deterioration from weather exposure, the flexible sheets 40, 41 may be covered with landscaping materials, such as mulch or gravel.

The present invention has been described with reference to certain preferred and alternative embodiments that are intended to be exemplary only and not limiting to the full scope of the present invention as set forth in the appended claims.

What is claimed is:

1. A device for assisting in the laying out of construction projects, comprising:
a flexible sheet of dimensionally stable material having a surface area at least as large as a substantial portion of an area of the construction project and further having imprinted thereon full-scale measurement indicia comprising a regular rectangular grid having a first plurality of lines at a first uniform spacing across a first dimension of said sheet and a second plurality of lines at a second uniform spacing across a second dimension of said sheet wherein said second plurality of lines is disposed at right angles to said first plurality of lines.

2. The device of claim 1 wherein said sheet comprises a plastic material.

3. The device of claim 2 wherein said plastic material is polyethylene.

4. The device of claim 1 wherein said sheet is substantially transparent.

5. The device of claim 1 wherein said first and said second uniform spacing is at one inch intervals.

6. The device of claim 1 wherein said first and said second uniform spacing is at one foot intervals.

7. The device of claim 1 further comprising visually enhanced grid lines.

8. The device of claim 7 wherein said visually enhanced grid lines comprise lines in a contrasting color to said first and said second plurality of lines.

9. The device of claim 8 wherein said visually enhanced grid lines are disposed on said sheet at a regular uniform interval.

10. The device of claim 9 wherein said regular uniform interval is twelve inches.

11. The device of claim 9 wherein said regular uniform interval is sixteen inches.

12. The device of claim 6 wherein said first and second plurality of lines further comprise indicator marks at one inch intervals.

13. The device of claim 9 wherein said visually enhanced grid lines further comprise indicator marks at one inch intervals.

14. The device of claim 1 wherein said first and second plurality of lines defines a plurality of squares, each of said squares having a center point and each of said center points having a center indicator mark imprinted thereon.

15. A device for assisting in the laying out of construction projects, comprising:
a flexible sheet of dimensionally stable material having a surface area at least as large as a substantial portion of an area of the construction project and further having imprinted thereon full-scale measurement indicia comprising a regular rectangular grid comprising a first plurality of lines spaced at intervals of one foot and a second plurality of lines spaced at intervals of one foot wherein said second plurality of lines is disposed at right angles to said first plurality of lines;
said first and second plurality of lines further having inch marks at one inch intervals;
and further wherein said first and second plurality of lines define a plurality of squares, each of said squares having a center point and further comprising a center indicator mark at each of said center points.

16. The device of claim 13 further comprising a third plurality of lines spaced at intervals of sixteen inches and a fourth plurality of lines spaced at sixteen inch intervals, and further wherein said first and second plurality of lines comprise a first color and said third and fourth plurality of lines comprise a second color.
